(19) United States
(12) Patent Application Publication
(10) Pub. No.: US 2025/0351852 A1
(43) Pub. Date: Nov. 20, 2025

(54) SOY PROTEIN-CONTAINING SHEET-LIKE COMPOSITION

(71) Applicant: J-OIL MILLS, INC., Chuo-ku, Tokyo (JP)

(72) Inventors: Kazuki HASHIMOTO, Tokyo (JP); Hiroshi ITO, Tokyo (JP); Yukiko OE, Tokyo (JP); Takashi SANO, Tokyo (JP)

(73) Assignee: J-OIL MILLS, INC., Chuo-ku, Tokyo (JP)

(21) Appl. No.: 18/874,397

(22) PCT Filed: Jun. 7, 2023
(86) PCT No.: PCT/JP2023/021181

§ 371 Date: Dec. 12, 2024

(30) Foreign Application Priority Data
Jun. 21, 2022 (JP) 2022-099694

(51) Int. Cl. A23L 11/45; A23J 3/16; A23L 29/00

(52) U.S. Cl. CPC A23L 11/45; A23J 3/16; A23L 29/04

(57) ABSTRACT

[Problem] To provide a soy protein-containing sheet-like composition having excellent texture and improved flexibility. [Solution] A soy protein-containing sheet-like composition containing soy protein and a medium-chain triglyceride. The medium-chain triglyceride preferably contains at least 90% by mass of fatty acid having 6 to 12 carbon atoms. The medium-chain fatty acid is preferably one or more selected from the group consisting of caproic acid, caprylic acid, capric acid, and lauric acid. The soy protein-containing sheet- like composition preferably contains 0.001 parts by mass to 10 parts by mass, inclusive, of the medium-chain triglyceride relative to 100 parts by mass of the soy protein.

### TECHNICAL FIELD

The present invention relates to a soy protein-containing sheet-like composition. More particularly, the present invention relates to a soy protein-containing sheet-like composition containing soy protein and a medium-chain triglyceride. The present invention also relates to a method for producing the soy protein-containing sheet-like composition. Furthermore, the present invention relates to a food product containing the soy protein-containing sheet-like composition.

### BACKGROUND ART

In recent years, it has become desirable to use plant protein-containing food products instead of meat protein-containing food products, not only for the growing number of vegetarians and vegans, but also for the general public with ideas of health consciousness and the like. Among them, soy protein-containing food products are characterized by the absence of cholesterol and lower calorie content than the meat protein-containing food products, and are used in various products. Among the various products mentioned above, soy protein-containing sheet-like food products are known, which can be used, for example, as skins for wrapping food products.

For example, a bubble-containing soy protein film is proposed, which has good tooth feeling, improved texture, and even excellent adhesion, by adding fine bubbles to an aqueous solution or suspension of soybeans before forming the film (Patent literature 1).

For example, a soy protein film with excellent heat and water resistance is proposed, which is obtained by forming a thin layer from an aqueous solution or suspension of soy protein prepared by adding calcium sulfate to soy protein and mixing it, followed by heating and drying (Patent literature 2).

For example, dough for a soy protein-containing sheet-like food product is proposed, which is characterized by dough containing soy protein, fat, carbohydrate, and water, wherein the composition ratio of the soy protein, fat, and carbohydrate is 1.2-2.5:1:0.3-1 (weight ratio) and the moisture content is 60-80% by weight (Patent literature 3).

For example, a method for producing a protein-containing sheet-like food product is proposed, which is characterized by blending an emulsified composition of dietary fiber-containing soybean, in which the dietary fiber content is 2.5% by weight or more, the protein content is 25% by weight or more on dry basis, the fat content (content as a chloroform/methanol mix solvent extract) is 25% by weight or more on dry basis, the moisture content is 70-90% by weight, and the fat content is 100% by weight or more relative to the protein content (Patent literature 4).

### CITATION LIST

### Patent Literature

Patent literature 1: Japanese Unexamined Patent Application Publication No. S60 (1985)-156354

Patent literature 2: Japanese Unexamined Patent Application Publication No. H02 (1990)-097359

Patent literature 3: Japanese Unexamined Patent Application Publication No. H09 (1997)-028304

Patent literature 4: Japanese Unexamined Patent Application Publication No. 2021-016348

### SUMMARY OF INVENTION

### Technical Problem

The soy protein-containing sheet-like food products, when free of oil/fat, retained the advantage of being low in calories, but were less flexible for use as food products. If a soy protein-containing sheet-like food product is less flexible and is used, for example, as a skin for wrapping food, it will tend to tear when fillings, etc. are wrapped in it.

The bubble-containing soy protein film described in Patent literature 1 and the soy protein film described in Patent literature 2 are very good from the point of view of reducing calories by not using oil/fat, but they have poor flexibility.

It is also known that the addition of oil/fat to soy protein-containing sheet-like food products improves the texture and peelability after baking, but soy protein-containing sheet-like food products with improved flexibility have not been obtained.

The dough for a soy protein-containing sheet-like food product described in Patent literature 3 was produced using a large amount of corn oil in each example, which was clearly disadvantageous from a caloric point of view. Furthermore, Patent literature 3 does not mention the flexibility of the dough for a soy protein-containing sheet-like food product.

The protein-containing sheet-like food product described in Patent literature 4 is a food product to which oil/fat is added to improve its peelability after baking, but the oil/fat is not added to improve the flexibility of the protein-containing sheet-like food product. Moreover, the protein-containing sheet-like food product in the example was produced using a large amount of rice oil, which was clearly disadvantageous from a caloric point of view.

No conventional soy protein-containing sheet-like food product has been able to provide both excellent texture and flexibility. Therefore, there is a need for a soy protein-containing sheet-like food product which is excellent in these two aspects.

The objective of the present invention is to provide a soy protein-containing sheet-like composition with excellent texture and improved flexibility.

In addition, the objective of the present invention is to provide a food product containing the soy protein-containing sheet-like composition.

In addition, the objective of the present invention is to provide a method for producing the soy protein-containing sheet-like composition.

### Solution to Problem

In view of the circumstances described above, the present inventors have made a diligent study and found that a soy protein-containing sheet-like composition with excellent texture and improved flexibility can be obtained by combining soy protein with a medium-chain triglyceride, thereby completing the present invention.

Specifically, the present invention relates to a soy protein-containing sheet-like composition comprising soy protein and a medium-chain triglyceride.

The medium-chain triglyceride is preferably one containing 90% by mass or more of a fatty acid having 6 to 12 carbon atoms.

The medium-chain fatty acid is preferably one or more selected from the group consisting of caproic acid, caprylic acid, capric acid, and lauric acid.

The soy protein-containing sheet-like composition preferably contains 0.001 parts or more but 10 parts or less by mass of the medium-chain triglyceride relative to 100 parts by mass of the soy protein.

In addition, the present invention relates to a food product containing the soy protein-containing sheet-like composition.

The present invention also relates to a method for producing a soy protein-

containing sheet-like composition, the method comprising:
a mixing step in which a medium-chain triglyceride and soy protein are mixed to obtain a mixture; and
a forming step in which the mixture is formed into a sheet-like shape.

In the above production method, the medium-chain triglyceride preferably contains 90% by mass or more of a fatty acid having 6 to 12 carbon atoms.

In the above production method, the medium-chain fatty acid is preferably one or more selected from the group consisting of caproic acid, caprylic acid, capric acid, and lauric acid.

In the above production method, the mixing step is preferably a step of mixing 0.001 parts or more but 10 parts or less by mass of the medium-chain triglyceride relative to 100 parts by mass of the soy protein to obtain a mixture.

In addition, the present invention relates to a method for producing a food product comprising a soy protein-containing sheet-like composition obtained by the above production method.

### ADVANTAGEOUS EFFECTS OF INVENTION

The present invention can provide a soy protein-containing sheet-like composition with excellent texture and improved flexibility by using a medium-chain triglyceride.

In addition, the present invention can provide a food product containing a soy protein-containing sheet-like composition in various forms by using the soy protein-containing sheet-like composition of the present invention, which has improved flexibility and is less likely to tear.

Furthermore, the present invention can provide a method for producing a soy protein-containing sheet-like composition with excellent texture and improved flexibility. In addition, the present invention can provide a method for producing a food product containing a soy protein-containing sheet-like composition in various forms having excellent texture and improved flexibility.

### DESCRIPTION OF EMBODIMENTS

### Soy Protein-Containing Sheet-Like Composition

The present invention relates to a soy protein-containing sheet-like composition comprising soy protein and a medium-chain triglyceride.

The term sheet-like as used herein refers to a flat plate-like shape and includes not only film-like, sheet-like, and other shapes, but also those having a certain thickness. The thickness is, for example, 1 cm or less, preferably 5 mm or less, more preferably 1 mm or less, still more preferably 0.5 mm or less, and yet still more preferably 0.3 mm or less. Furthermore, the thickness can be, for example, 0.001 mm or more, 0.005 mm or more, 0.01 mm or more, 0.05 mm or more, or 0.1 mm or more.

### Soy Protein

The soy protein used as a raw ingredient in the soy protein-containing sheet-like composition of the present invention is not particularly limited as long as it is an ingredient containing soy protein. For example, soy flour such as full-fat soy flour and defatted soy flour, isolated soy protein, soy milk powder, etc. can be used. Among them, isolated soy protein is preferred, and its production method is not particularly limited. For example, it can be produced using defatted soybeans as a raw ingredient. There is also no particular restriction on its characteristics, and examples include powder, granular, paste, and fibrous forms. It is preferable to use isolated soy protein isolated and purified from defatted soy flour. Since the form of the isolated soy protein described above is generally in powder form, it has the advantage of being able to be handled in the same way as flour. It is also possible to obtain a soy protein-containing sheet-like composition of the present invention by using soy protein with a protein content of 70% or more, called concentrated soy protein.

Commercially available products can be used as the soy protein, and examples include, but are not limited to, the following.

For example, Fujipro (registered trademark) F (manufactured by Fuji Oil Co., Ltd.) and the like.

### Medium-Chain Triglyceride

A medium-chain triglyceride (hereinafter, also referred to as MCT) is oil/fat produced from a medium-chain fatty acid contained in, for example, coconut oil or palm kernel oil.

Medium-chain triglycerides are compounds that have the structure of three medium-chain fatty acids linked to a glycerol via ester bonds. Herein, a medium-chain triglyceride is a triglyceride having saturated fatty acids with 6 to 12 carbon atoms as the component fatty acids. Examples of the saturated fatty acids with 6 to 12 carbon atoms include caproic acid (a saturated fatty acid with 6 carbon atoms, hereinafter also referred to herein as C₆), caprylic acid (a saturated fatty acid with 8 carbon atoms, hereinafter also referred to herein as C₈), capric acid (a saturated fatty acid with 10 carbon atoms, hereinafter also referred to herein as C₁₀), and lauric acid (a saturated fatty acid with 12 carbon atoms, hereinafter also referred to herein as C₁₂).

A single medium-chain triglyceride molecule may consist of one type of medium-chain fatty acids, or it may contain two or three types of medium-chain fatty acids. Alternatively, a mixture of several types of medium-chain triglyceride molecules may also be used.

Examples of the combination of the component fatty acids and their content (mass %) in the medium-chain triglyceride used in the soy protein-containing sheet-like composition of the present invention include those exemplified in (1)-(15) below, provided that they do not exceed 100% in total. Examples of other components listed below include medium-chain fatty acids, diglycerides and monoglycerides of medium-chain fatty acids, and glycerides containing short-chain fatty acids with 5 or less carbon atoms or long-chain fatty acids with 13 or more carbon atoms, which may be used together as long as they do not interfere with the effects of the present invention.
(1) C₆; 90% or more but 100% or less, preferably 99% or more but 100% or less.

Other components; 0% or more but 10% or less, preferably 0% or more but 1.0% or less.
(2) C₈; 90% or more but 100% or less, preferably 99% or more but 100% or less.

Other components; 0% or more but 10% or less, preferably 0% or more but 1.0% or less.
(3) C₁₀; 90% or more but 100% or less, preferably 99% or more but 100% or less.

Other components; 0% or more but 10% or less, preferably 0% or more but 1.0% or less.
(4) C₁₂; 90% or more but 100% or less, preferably 99% or more but 100% or less.

Other components; 0% or more but 10% or less, preferably 0% or more but 1.0% or less.
(5) C₆; 0.1% or more but 99.9% or less, preferably 0.5% or more but 99.9% or less.

C₈; 0.1% or more but 99.9% or less, preferably 10% or more but 99.9% or less.

Other components; 0% or more but 10% or less, preferably 0% or more but 1.0% or less.
(6) C₆; 0.1% or more but 99.9% or less, preferably 0.5% or more but 99.9% or less.

C_{10; 0.1}% or more but 99.9% or less, preferably 10% or more but 99.9% or less.

Other components; 0% or more but 10% or less, preferably 0% or more but 1.0% or less.
(7) C₆; 0.1% or more but 99.9% or less, preferably 0.5% or more but 99.9% or less.

C₁₂; 0.1% or more but 99.9% or less, preferably 10% or more but 99.9% or less.

Other components; 0% or more but 10% or less, preferably 0% or more but 1.0% or less.
(8) C₈; 0.1% or more but 99.9% or less, preferably 10% or more but 99.9% or less.

C₁₀; 0.1% or more but 99.9% or less, preferably 10% or more but 99.9% or less.

Other components; 0% or more but 10% or less, preferably 0% or more but 1.0% or less.
(9) C₈; 0.1% or more but 99.9% or less, preferably 10% or more but 99.9% or less.

C₁₂; 0.1% or more but 99.9% or less, preferably 10% or more but 99.9% or less.

Other components; 0% or more but 10% or less, preferably 0% or more but 1.0% or less.
(10) C₁₀; 0.1% or more but 99.9% or less, preferably 10% or more but 99.9% or less.

C_{12; 0.1}% or more but 99.9% or less, preferably 10% or more but 99.9% or less.

Other components; 0% or more but 10% or less, preferably 0% or more but 1.0% or less.
(11) C₆; 0.1% or more but 99.8% or less, preferably 0.5% or more but 99.8% or less.

C₈; 0.1% or more but 99.8% or less, preferably 10% or more but 97.5% or less.

C₁₀; 0.1% or more but 99.8% or less, preferably 2.0% or more but 99.8% or less.

Other components; 0% or more but 10% or less, preferably 0% or more but 1.0% or less.
(12) C₆; 0.1% or more but 99.8% or less, preferably 0.5% or more but 99.8% or less.

C₈; 0.1% or more but 99.8% or less, preferably 10% or more but 99.8% or less.

C₁₂; 0.1% or more but 99.8% or less, preferably 10% or more but 99.8% or less.

Other components; 0% or more but 10% or less, preferably 0% or more but 1.0% or less.
(13) C₆; 0.1% or more but 99.8% or less, preferably 0.5% or more but 99.8% or less.

C₁₀; 0.1% or more but 99.8% or less, preferably 2.0% or more but 99.8% or less.

C₁₂; 0.1% or more but 99.8% or less, preferably 10% or more but 99.8% or less.

Other components; 0% or more but 10% or less, preferably 0% or more but 1.0% or less.
(14) C₈; 0.1% or more but 99.8% or less, preferably 10% or more but 99.8% or less.

C_{10; 0.1}% or more but 99.8% or less, preferably 2.0% or more but 99.8% or less.

C_{12; 0.1}% or more but 99.8% or less, preferably 10% or more but 99.8% or less.

Other components; 0% or more but 10% or less, preferably 0% or more but 1.0% or less.
(15) C₆; 0.1% or more but 99.7% or less, preferably 0.2% or more but 99.7% or less, more preferably 0.3% or more but 99.7% or less, still more preferably 0.3% or more but 2.0% or less.

C₈; 0.1% or more but 99.7% or less, preferably 10% or more but 99.7% or less, more preferably 37.0% or more but 99.7% or less, still more preferably 37.0% or more but 82.0% or less.

C₁₀; 0.1% or more but 99.7% or less, preferably 10% or more but 99.7% or less, more preferably 17.0% or more but 99.7% or less, still more preferably 17.0% or more but 34.0% or less.

C₁₂; 0.1% or more but 99.7% or less, preferably 0.2% or more but 99.7% or less, more preferably 0.3% or more but 99.7% or less, still more preferably 0.3% or more but 21.0% or less.

Other components; 0% or more but 10% or less, preferably 0% or more but 1.0% or less.

Of the above combinations (1)-(15), combinations selected from (5)-(15) are preferred, combinations selected from (8)-(15) are more preferred, and combinations selected from (8), (11) and (15) are even more preferred. The medium-chain triglyceride of the above combination preferably contains 90% by mass or more, more preferably 91% by mass or more, still more preferably 92% by mass or more, in particular 93% by mass or more, 94% by mass or more, 95% by mass or more, 96% by mass or more, 97% by mass or more, 98% by mass or more, and particularly preferably 99% by mass or more of fatty acids having 6 to 12 carbon atoms.

As the medium-chain triglyceride, those produced from natural products such as coconut oil and palm kernel oil as described above as well as those produced by chemical synthesis can be used. Medium-chain triglycerides are also commercially available and it is possible to use them. Examples include, but are not limited to, the following.

For example, COCONARD (registered trademark) RK (manufactured by Kao Corporation), COCONARD (registered trademark) MT (manufactured by Kao Corporation), and COCONARD (registered trademark) ML (manufactured by Kao Corporation).

The content of the medium-chain fatty triglyceride in the soy protein-containing sheet-like composition of the present invention can be adjusted as desired as long as the effect of the present invention is not impaired. For example, the content is 0.001 parts or more but 10 parts or less by mass, 0.001 parts or more but 7.0 parts or less by mass, or 0.001 parts or more but 3.5 parts or less by mass, relative to 100 parts by mass of the soy protein.

The medium-chain triglyceride content in the above range allows the formation of a soy protein-containing sheet-like composition of the present invention, which has an excellent texture and improved flexibility.

The present invention can provide a soy protein-containing sheet-like composition with excellent texture and improved flexibility by adding a medium-chain triglyceride, which is neither mentioned nor suggested in Patent literature 3 and 4, in a small amount. Furthermore, the soy protein-containing sheet-like composition of the present invention can retain the advantage of being low in calories of the oil/fat-free soy protein films described in Patent literature 1 and 2 because the amount of the medium-chain triglyceride used is small.

Other additives

The soy protein-containing sheet-like composition of the present invention may be supplemented with various additives customarily used in the food industry as long as the effects of the present invention are not impaired. Examples of such additives include food ingredients (fruit juices, fruit pulp, vegetables, sugars, salt, oils/fats, starches, cacao mass, poultry, animal, and fish meat products, etc.) and food additives (minerals such as calcium lactate, light calcium carbonate, zinc gluconate, zinc sulfate, copper gluconate, and copper sulfate, vitamins such as vitamin A, B vitamins, vitamin E, and vitamin K, emulsifiers, thickening and stabilizing agents, acidifiers, flavoring agents, dyes, preservatives, etc.) for adjusting flavor, texture, etc. Examples of such additives also include seeds, seaweeds, leaves, and dietary fiber. In addition, seasonings such as monosodium glutamate, monosodium inosinate, monosodium guanylate, sugar beet oligosaccharide, and oligosaccharide syrup, acidifiers such as citric acid and malic acid, glues such as sodium alginate, moisturizers such as sorbitol and glycerol may also be added to the soy protein-containing sheet-like composition of the present invention as needed.

One or more of the above additives may be added.

### Method for Producing Soy Protein-Containing Sheet-Like Composition

A method for producing a soy protein-containing sheet-like composition of the present invention comprises: a mixing step in which a medium-chain triglyceride and soy protein are mixed to obtain a mixture; and a forming step in which the mixture is formed into a sheet-like shape. For the medium-chain triglyceride, soy protein, etc., those described above can be used.

### Mixing Step

In the mixing step, any method conventionally known in the art may be used as appropriate as the method of mixing the medium-chain triglyceride and the soy protein, etc. For example, a stirrer can be used to mix the medium-chain triglyceride and the soy protein. In the mixing step, all the raw ingredients to be mixed, including the medium-chain triglyceride, may be pre-mixed before mixing with the soy protein, all the raw ingredients to be mixed, including the medium-chain triglyceride, may be mixed with the soy protein all at once, or the raw ingredients to be mixed, including the medium-chain triglyceride, may be mixed with the soy protein in several separate batches. The raw ingredients to be mixed, including the medium-chain triglyceride, may be added to a container that contains the soy protein, or the soy protein may be added to a container used for the mixing step that already contains the raw ingredients to be mixed, including the medium-chain triglyceride. A mixture of the medium-chain triglyceride and the soy protein is obtained by the above mixing step (hereinafter referred to herein as “dough of the soy protein-containing sheet-like composition” or simply as “dough”).

The dough of the soy protein-containing sheet-like composition of the present invention may contain moisture.

When moisture is added during the mixing step, the moisture content is usually 10 parts or more but 500 parts or less by mass, for example, 50 parts or more but 400 parts or less by mass, relative to 100 parts by mass of total solids content in the dough of the soy protein-containing sheet-like composition. The solids content refers to the components of the dough excluding the moisture.

Equipment used in the mixing step may be known equipment such as a whisk, a mixer, etc. An example of commercially available equipment includes, but is not limited to, the following. For example, HM-T900 (manufactured by Dretec Co., Ltd.) can be used as a mixer.

### Forming Step

In the forming step, the dough obtained in the mixing step described above is formed into a sheet-like shape. The method of forming the dough into a sheet-like shape depends on the properties of the dough, but any method conventionally known in the art may be used as appropriate.

The method of forming the dough into a sheet-like shape may be, for example, a method in which the dough is formed into a sheet-like shape using an extruder, a method in which the dough is rolled using a roller, or a method in which the dough is filled into a retainer and formed into a sheet-like shape. The sheet-like dough formed as described above is usually dried, heat-dried, or baked to obtain a soy protein-containing sheet-like composition. If the dough is in the form of an aqueous solution or suspension, it may be poured into a suitable mold or spread on a smooth surface or the like for drying, heat drying, or baking. The dough that has been formed into a sheet-like shape is usually cut into an appropriate size. Cutting the dough into an appropriate size can be done before, during, or after drying, heat drying, or baking, but it is preferable to do so after drying, heat drying, or baking. Therefore, it is preferable, for example, to form the dough into a sheet-like shape, dry, heat dry or bake it, then collect it on a roll, and thereafter cut it into an appropriate size.

The means of heat drying or baking the dough is not particularly limited, and a conventional method such as oven heating, microwave heating, heating by deep-frying in oil, heating on a heated iron plate, etc., and grilling can be used. For example, known equipment such as an oven can be used as a means of heat drying or baking the dough. An example of commercially available equipment includes, but is not limited to, the following.

For example, a convection oven (Super Steam MINI SSC-03, manufactured by Maruzen Co., Ltd.) can be used as an oven.

The time for drying, heat drying or baking is not constant depending on the amount of raw ingredients used, the thickness of the sheet, and the like, but usually the conditions are set so that the drying, heat drying or baking is completed within a period of 30 seconds or longer but 72 hours or shorter, preferably 1 minute or longer but 48 hours shorter, and more preferably 2 minutes or longer but 24 hours or shorter. For example, it is preferable to place the dough in a preheated oven for heat drying or baking, then remove it and allow it to cool to room temperature.

Heat drying or baking can usually be performed within the temperature range of 25° C. or higher. However, when considering economical production, including the amount of raw ingredients used, the temperature range is, for example, preferably 40° C. or higher but 180° C. or lower, more preferably 60° C. or higher but 170° C. or lower, and still more preferably 80° C. or higher but 160° C. or lower.

The method for producing a soy protein-containing sheet-like composition of the present invention can provide a soy protein-containing sheet-like composition with excellent texture and improved flexibility.

The flexibility of the soy protein-containing sheet-like composition of the present invention is expressed as the distance at the maximum stress when the soy protein-containing sheet-like composition is pulled until it tears using a texture analyzer, which is, for example, 0.7 mm or more, preferably 1.0 mm or more, and more preferably 1.1 mm or more.

### Food Products Containing Soy Protein-Containing Sheet-Like Composition

The soy protein-containing sheet-like composition of the present invention can be used as a skin for wrapping various foods. The soy protein-containing sheet-like composition of the present invention can be used, for example, as wrappers for sushi, wrappers for rice, crepes, tortillas, lumpia skins, salad skins, fresh spring roll skins, spring roll skins, edible films, etc. The soy protein-containing sheet-like composition of the present invention can also be used as skin materials for Japanese confectionery such as yokan (gelled red bean paste) and manju (bun filled with red bean paste), skin materials for Western confectionery such as cakes, and skins for foods such as ice cream, jam, and jelly. In particular, the soy protein-containing sheet-like composition of the present invention can be advantageously used as a wrapper for sushi. Furthermore, the soy protein-containing sheet-like composition of the present invention can be modified into a yuba (bean curd skin)-like form, a deep-fried tofu (bean curd)-like form, or the like for use as an ingredient in various dishes or retort pouch food products. Food products using these soy protein-containing sheet-like compositions of the present invention and methods for producing the same are included within the scope of the present invention. Thus, for example, if the soy protein-containing sheet-like composition of the present invention is used as a wrapper for sushi, and sushi rolls are prepared by wrapping rice and desired ingredients such as avocado and crab, the sushi rolls and the method for preparing them are included within the scope of the present invention.

### EXAMPLES

Hereinafter, the present invention will be described more specifically by way of examples, but the present invention is not limited to the following examples.

The medium-chain triglycerides (MCTs) and oils/fats listed in Table 1 were used in the examples of the present invention and comparative examples.

TABLE 1
Medium-chain triglycerides (MCTs) and oils/fats

| Oil/fat | Fatty acid composition | Product name of oil/fat |
|---|---|---|
| MCT(A) | C₆ 0.5 mass %, | COCONARD (registered |
| | C₈ 97.3 mass %, | trademark) RK |
| | C₁₀ 2.2% mass % | (manufactured by Kao Corporation) |
| MCT(B) | C₆ 0.3 mass %, | COCONARD (registered |
| | C₈ 81.6 mass %, | trademark) MT |
| | C₁₀ 17.4 mass %, | (manufactured by Kao Corporation) |
| | C₁₂ 0.4 mass % | |
| MCT(C) | C₆ 1.9 mass %, | COCONARD (registered |
| | C₈ 37.6 mass %, | trademark) ML |
| | C₁₀ 33.9 mass %, | (manufactured by Kao Corporation) |
| | C₁₂ 20.2 mass % | |
| Rapeseed | C₆-C₁₂ fatty acids: | AJINOMOTO (registered trademark) |
| oil | 0 mass % | Sarasara (registered |
| | | trademark) Canola oil |
| | | (manufactured by J-OIL MILLS) |
| Soybean | C₆-C₁₂ fatty acids: | AJINOMOTO (registered trademark) |
| oil | 0 mass % | Soybean salad oil |
| | | (manufactured by J-OIL |
| | | MILLS) |
| Rice bran | C₆-C₁₂ fatty acids: | AJINOMOTO (registered trademark) |
| oil | 0 mass % | Rice bran oil (manufactured |
| | | by J-OIL MILLS) |
| Corn oil | C₆-C₁₂ fatty acids: | Corn oil (manufactured by |
| | 0 mass % | J-OIL MILLS) |

### Example 1

17 g of glycerin (Glycerin (food additive), manufactured by Kao Corporation), 1.4 g of sorbitol (C*PharmSorbidex P 16616, manufactured by Cargill, Incorporated), 0.5 g of MCT (A) [COCONARD (registered trademark) RK, manufactured by Kao Corporation], and 280 g of water were placed in a bowl, and mixed using a hand mixer (HM-T900; whisk/beater, manufactured by Dretec Co., Ltd.) at speed 1 for 15 seconds, then 60 g of isolated soy protein [Fujipro (registered trademark) F, manufactured by Fuji Oil Co., Ltd.] was added, and mixed using the hand mixer at speed 1 for 1 minute. The isolated soy protein on the inner wall of the bowl was dropped using a spatula and mixed at speed 5 for 3 minutes to obtain dough.

Then, a 0.5 mm thick silicone rubber sheet with a cutout that was 50 mm long and 20 mm wide was placed as mold on a Teflon (registered trademark) sheet, and the silicone rubber sheet mold was filled with the dough. After scraping off the dough outside the mold, the silicone rubber sheet was peeled off, thereby forming the dough into a sheet-like shape.

Meanwhile, a convection oven (Super Steam MINI SSC-03, manufactured by Maruzen Co., Ltd.) was preheated to 95° C., and the convection oven was set to 90° C. before placing the Teflon (registered trademark) sheet having the sheet-like shaped dough thereon in the convection oven. After the dough was placed in the convection oven for 1 minute, the convection oven was set to 95° C. After heating at 95° C. for 2 minutes, the Teflon (registered trademark) sheet having the dough thereon was removed from the convection oven. The dough was air cooled at room temperature for 30 minutes to obtain a soy protein-containing sheet-like composition of Example 1 having a thickness of about 0.5 mm.

### Example 2

A soy protein-containing sheet-like composition of Example 2 was obtained in the same manner as in Example 1, except that 0.5 g of MCT (B) was used instead of MCT (A).

### Example 3

A soy protein-containing sheet-like composition of Example 3 was obtained in the same manner as in Example 1, except that 0.5 g of MCT (C) was used instead of MCT (A).

### Example 4

A soy protein-containing sheet-like composition of Example 4 was obtained in the same manner as in Example 1, except that 0.1 g of MCT (B) was used instead of MCT (A).

### Example 5

A soy protein-containing sheet-like composition of Example 5 was obtained in the same manner as in Example 1, except that 1.3 g of MCT (B) was used instead of MCT (A).

### Example 6

A soy protein-containing sheet-like composition of Example 6 was obtained in the same manner as in Example 1, except that 2.0 g of MCT (B) was used instead of MCT (A).

### Comparative Example 1

A soy protein-containing sheet-like composition of Comparative example 1 was obtained in the same manner as in Example 1, except that 0.5 g of rapeseed oil was used instead of MCT (A).

### Comparative Example 2

A soy protein-containing sheet-like composition of Comparative example 2 was obtained in the same manner as in Example 1, except that 0.5 g of soybean oil was used instead of MCT (A).

### Comparative Example 3

A soy protein-containing sheet-like composition of Comparative example 3 was obtained in the same manner as in Example 1, except that 0.5 g of rice bran oil was used instead of MCT (A).

### Comparative Example 4

A soy protein-containing sheet-like composition of Comparative example 4 was obtained in the same manner as in Example 1, except that 0.5 g of corn oil was used instead of MCT (A).

### Control Example

A soy protein-containing sheet-like composition of a control example was obtained in the same manner as in Example 1, except that MCT (A) was not added.

### Evaluation of Flexibility of Soy Protein-Containing Sheet-Like Compositions

A texture analyzer (TA.XTplus, manufactured by Stable Micro Systems) was used to evaluate the flexibility of the soy protein-containing sheet-like compositions of Examples 1 to 6, Comparative examples 1 to 4, and the control example. First, fixtures for tensile test were used to grip the soy protein-containing sheet-like compositions of Examples 1 to 6, Comparative examples 1 to 4, and the control example, so that the distance between the fixtures was 20 mm. Each soy protein-containing sheet-like composition was then pulled at a tensile rate of 0.1 mm/sec until it broke, and the distance at the maximum stress was measured. Measurements were performed on 5 samples and the average of the data was calculated to evaluate flexibility as the distance at the maximum stress. The results are shown in Table 2.

TABLE 2
Data from instrumental analysis

| | Distance (mm): Flexibility |
|---|---|
| Control example | 0.6 |
| Example 1 | 1.4 |
| Example 2 | 1.1 |
| Example 3 | 1.4 |
| Example 4 | 3.5 |
| Example 5 | 4.3 |
| Example 6 | 4.9 |
| Comparative example 1 | 0.7 |
| Comparative example 2 | 2.5 |
| Comparative example 3 | 1.9 |
| Comparative example 4 | 0.9 |

As shown in Table 2, the flexibility of the soy protein-containing sheet-like compositions of Examples 1 to 6 of the present invention was improved compared to the soy protein-containing sheet-like composition of the control example without oil/fat. In particular, the soy protein-containing sheet-like compositions of Examples 5 and 6 showed a significant improvement in flexibility.

### Sensory Evaluation of Texture of Soy Protein-Containing Sheet-Like Compositions

The “meltability in the mouth” and “lingering texture in the mouth” of the soy protein-containing sheet-like compositions at the time of consumption were evaluated. The texture evaluation results (scores) were obtained by rating by a panel of five members and calculating the average of the scores given by the members. The results are shown in Table 3.

Meltability in the mouth was rated on the following five scales for the ease of melting when placed in the mouth.

Meltability in the mouth) 5: Very good meltability in the mouth, 4: Good meltability in the mouth, 3: Remains slightly in the mouth, 2: Remains in the mouth, 1: Remains very clear in the mouth.

Lingering texture in the mouth was rated on the following five scales for the roughness remaining in the mouth after being placed in the mouth for a while.

Lingering texture in the mouth) 5: Very smooth and creamy, 4: Smooth, 3: Slightly rough, 2: Rough, 1: Rough and bad texture on the tongue.

TABLE 3
Sensory evaluation

| | Meltability in the | Lingering texture in |
|---|---|---|
| | mouth | the mouth |
| Control example | 3.8 | 3.0 |
| Example 1 | 3.8 | 3.8 |
| Example 2 | 4.0 | 3.8 |
| Example 3 | 4.0 | 3.8 |
| Example 4 | 4.2 | 4.2 |
| Example 5 | 5 | 5 |
| Example 6 | 5 | 5 |
| Comparative example 1 | 3.8 | 3.0 |
| Comparative example 2 | 2.2 | 2.4 |
| Comparative example 3 | 3.4 | 3.0 |
| Comparative example 4 | 3.8 | 3.0 |

As shown in Table 3, the soy protein-containing sheet-like compositions of Examples 1 to 6, to which the medium-chain triglyceride was added, had good or very good ratings for the meltability and lingering texture in the mouth. In addition, as shown in Table 2 above, the soy protein-containing sheet-like compositions of Examples 1 to 6 were found to have excellent flexibility and to be very suitable as skins for wrapping various foods, especially as wrappers for sushi.

On the other hand, the soy protein-containing sheet-like composition of Comparative example 1, to which rapeseed oil was added, had a rather rough texture when evaluated for the lingering texture in the mouth and did not show excellent flexibility as shown in Table 2 above. Therefore, it was found to be unsuitable as a skin for wrapping various foods, especially as a wrapper for sushi.

The soy protein-containing sheet-like composition of Comparative example 2, to which soybean oil was added, showed sufficient flexibility compared to the soy protein-containing sheet-like compositions of Examples 1 to 3 as shown in Table 2 above. However, the meltability in the mouth was not good as the product remained in the mouth, and the lingering texture in the mouth was not good as it had a rough texture. Therefore, it was found to be unsuitable as a skin for wrapping various foods, especially as a wrapper for sushi.

The soy protein-containing sheet-like composition of Comparative example 3, to which rice bran oil was added, showed sufficient flexibility compared to the soy protein-containing sheet-like compositions of Examples 1 to 3 as shown in Table 2 above. However, the lingering texture in the mouth was not good as it had a slightly rough texture. Therefore, it was found to be unsuitable as a skin for wrapping various foods, especially as a wrapper for sushi.

The soy protein-containing sheet-like composition of Comparative example 4, to which corn oil was added, did not give excellent result in terms of flexibility as shown in Table 2 above. Furthermore, the lingering texture in the mouth was not good as it had a slightly rough texture. Therefore, it was found to be unsuitable as a skin for wrapping various foods, especially as a wrapper for sushi.

The soy protein-containing sheet-like composition of the control example, to which no oil/fat was added, did not give excellent result in terms of flexibility as shown in

Table 2 above. Furthermore, the lingering texture in the mouth was not good as it had a slightly rough texture. Therefore, it was found to be unsuitable as a skin for wrapping various foods, especially as a wrapper for sushi.

Accordingly, the soy protein-containing sheet-like compositions which were evaluated as having excellent texture in terms of both the “meltability in the mouth” and “lingering texture in the mouth” as well as excellent flexibility were not found among the soy protein-containing sheet-like compositions of Comparative examples 1 to 4, to which oils/fats other than the medium-chain triglyceride were added, and the soy protein-containing sheet-like composition of the control example, to which no oil/fat was added.

Thus, the advantage of the soy protein-containing sheet-like compositions of Examples 1 to 6, to which the medium-chain triglyceride of the present invention was added, was demonstrated.

1. A soy protein-containing sheet-like composition comprising soy protein and a medium-chain triglyceride.

2. The soy protein-containing sheet-like composition according to claim 1, wherein the medium-chain triglyceride contains 90% by mass or more of a fatty acid having 6 to 12 carbon atoms.

3. The soy protein-containing sheet-like composition according to claim 1, wherein the medium-chain fatty acid is one or more selected from the group consisting of caproic acid, caprylic acid, capric acid, and lauric acid.

4. The soy protein-containing sheet-like composition according to claim 1, comprising 0.001 parts or more but 10 parts or less by mass of the medium-chain triglyceride relative to 100 parts by mass of the soy protein.

5. A food product containing the soy protein-containing sheet-like composition according to claim 1.

6. A method for producing a soy protein-containing sheet-like composition, comprising:
a mixing step in which a medium-chain triglyceride and soy protein are mixed to obtain a mixture; and
a forming step in which the mixture is formed into a sheet-like shape.

7. The method for producing a soy protein-containing sheet-like composition according to claim 6, wherein the medium-chain triglyceride contains 90% by mass or more of a fatty acid having 6 to 12 carbon atoms.

8. The method for producing a soy protein-containing sheet-like composition according to claim 6, wherein the medium-chain fatty acid is one or more selected from the group consisting of caproic acid, caprylic acid, capric acid, and lauric acid.

9. The method for producing a soy protein-containing sheet-like composition according to claim 6, wherein the mixing step is a step of mixing 0.001 parts or more but 10 parts or less by mass of the medium-chain triglyceride relative to 100 parts by mass of the soy protein to obtain a mixture.

10. A method for producing a food product comprising a soy protein-containing sheet-like composition obtained by the method according to claim 6.
